(19) United States
(12) Patent Application Publication
(10) Pub. No.: US 2022/0376842 A1
(43) Pub. Date: Nov. 24, 2022

(54) APPARATUS AND METHOD OF SIDELINK BSR REPORTING

(71) Applicant: Lenovo (Beijing) Ltd., Beijing (CN)

(72) Inventors: Jing Han, Chaoyang District (CN); Joachim Löhr, Wiesbaden (DE); Lianhai Wu, Chaoyang (CN); Prateek Basu Mallick, Dreieich (DE); Haiming Wang, Xicheng District (CN)

(73) Assignee: Lenovo (Beijing) Ltd., Beijing (CN)

(21) Appl. No.: 17/773,820

(22) PCT Filed: Nov. 8, 2019
(86) PCT No.: PCT/CN2019/116659

§ 371 Date: May 2, 2022

(51) Int. Cl. H04L 1/18

(52) U.S. Cl. CPC H04L 1/1835; H04L 1/1812

(57) ABSTRACT

Apparatus and methods of Sidelink (SL) Buffer Status Report (BSR) reporting for New Radio (NR) Vehicle-to-Everything (V2X) Communication are disclosed. The apparatus includes: a processor that arranges buffer size information for sidelink (SL) transmission into a plurality of buffer groups based on a destination ID and at least one selected from a group consisting of: a cast type and a Hybrid Automatic Repeat Request (HARQ) feedback mode; and a transmitter that transmits the buffer size information, according to the buffer groups.

### FIELD

The subject matter disclosed herein relates generally to wireless communication and more particularly relates to, but not limited to, apparatus and methods of Sidelink (SL) Buffer Status Report (BSR) reporting for New Radio (NR) Vehicle-to-Everything (V2X) Communication.

### BACKGROUND

The following abbreviations and acronyms are herewith defined, at least some of which are referred to within the following description.

Third Generation Partnership Project (3GPP), 5th Generation (5G), New Radio (NR), 5G Node B/generalized Node B (gNB), Long Term Evolution (LTE), LTE Advanced (LTE-A), E-UTRAN Node B/Evolved Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Entity/Equipment (UE), Network Equipment (NE), Radio Access Technology (RAT), Receive or Receiver (RX), Transmit or Transmitter (TX), Hybrid Automatic Repeat Request (HARQ), Acknowledgement (ACK), Negative Acknowledgement (NACK), Physical Uplink Control Channel (PUCCH), Physical Uplink Shared Channel (PUSCH), Buffer Status Report (BSR), Control Element (CE), Central Processing Unit (CPU), Device to Device (D2D), Identification (ID), Logical Channel Group (LCG), Logical Channel (LCH), Light Emitting Diode (LED), Media Access Control (MAC), Protocol Data Unit (PDU), Proximity Service (ProSe), Quality of Service (QoS), Random-access Memory (RAM), Radio Resource Control (RRC), Sidelink (SL), Transport Block (TB), Vehicle-to-Everything (V2X), Frequency Range 1 (FR1), Frequency Range 2 (FR2), Vehicle-to-Vehicle (V2V), Compact Disc Read-Only Memory (CD-ROM), Dynamic RAM (DRAM), Field Programmable Gate Array (FPGA), Graphics Processing Unit (GPU), Liquid Crystal Display (LCD), Organic LED (OLED), Read-only Memory (ROM), Synchronous Dynamic RAM (SDRAM), Static RAM (SRAM), Very-large-scale Integration (VLSI), Vehicle-to-Infrastructure (V2I), Vehicle-to-Network (V2N), Vehicle-to-Pedestrian (V2P), Vehicle-to-Device (V2D), Vehicle-to-Grid (V2G), Cellular V2X (C-V2X), Logical Channel Prioritization (LCP), Network (NW), PC5 QoS Indicator (PQI), Guaranteed Flow Bit Rate (GFBR), Maximum Flow Bit Rate (MFBR). As used herein, “HARQ-ACK” may represent collectively the Positive Acknowledge (ACK) and the Negative Acknowledge (NACK). ACK means that a TB is correctly received while NACK means a TB is erroneously received.

In wireless communication, such as a Third Generation Partnership Project (3GPP) mobile network, a wireless mobile network may provide a seamless wireless communication service to a wireless communication terminal having mobility, i.e. user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Vehicle-to-everything (V2X) communication is the passing of information from a vehicle to any entity that may affect the vehicle, and vice versa. It is a vehicular communication system that incorporates other more specific types of communication as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid). V2X is the key technology of the future intelligent transportation system, and its application will enhance road safety and traffic efficiency, reducing congestion and energy consumption. There are two types of V2X communication technology depending on the underlying technology being used: WLAN-based and cellular-based.

V2X communication using wireless mobile networks is called cellular V2X (or C-V2X) to differentiate it from the WLAN-based V2X. 3GPP published V2X specifications based on LTE as the underlying technology in 2016 and has continued to expand the V2X functionalities to support fifth generation (5G) access networks, which may also be referred to as New Radio (NR) access networks.

### SUMMARY

Apparatus and methods of Sidelink (SL) Buffer Status Report (BSR) reporting for New Radio (NR) Vehicle-to-Everything (V2X) Communication are disclosed.

According to a first aspect, there is provided an apparatus, comprising: a processor that arranges buffer size information for sidelink (SL) transmission into a plurality of buffer groups based on a destination ID and at least one selected from a group consisting of: a cast type and a Hybrid Automatic Repeat Request (HARQ) feedback mode; and a transmitter that transmits the buffer size information, according to the buffer groups.

According to a second aspect, there is provided an apparatus, comprising: a receiver that receives buffer size information for sidelink (SL) transmission, the buffer size information being arranged into a plurality of buffer groups based on a destination ID and at least one selected from a group consisting of: a cast type and a Hybrid Automatic Repeat Request (HARQ) feedback mode; and a processor that schedules radio resources for SL transmission based on the buffer size information, according to the buffer groups.

According to a third aspect, there is provided a method, comprising: arranging, by a processor, buffer size information for sidelink (SL) transmission into a plurality of buffer groups based on a destination ID and at least one selected from a group consisting of: a cast type and a Hybrid Automatic Repeat Request (HARQ) feedback mode; and transmitting, by a transmitter, the buffer size information, according to the buffer groups.

According to a fourth aspect, there is provided a method, comprising: receiving, by a receiver, buffer size information for sidelink (SL) transmission, the buffer size information being arranged into a plurality of buffer groups based on a destination ID and at least one selected from a group consisting of: a cast type and a Hybrid Automatic Repeat Request (HARQ) feedback mode; and scheduling, by a processor, radio resources for SL transmission based on the buffer size information, according to the buffer groups.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system;

FIG. 2 is a schematic block diagram illustrating components of user equipment (UE) according to one embodiment;

FIG. 3 is a schematic block diagram illustrating components of network equipment (NE) according to one embodiment;

FIG. 4A is a schematic diagram illustrating Sidelink BSR and Truncated Sidelink BSR Media Access Control (MAC) control element (CE) for even N;

FIG. 4B is a schematic diagram illustrating Sidelink BSR and Truncated Sidelink BSR MAC CE for odd N;

FIG. 5A is a schematic diagram illustrating a SL-BSR MAC CE format structure considering Logical Channel Prioritization (LCP) restriction;

FIG. 5B is a schematic diagram illustrating a SL-BSR MAC CE format with a cast type field and a HARQ feedback mode field;

FIG. 6A is a schematic diagram illustrating a Logical Channel Group (LCG) configuration with cast-type and HARQ feedback mode explicitly;

FIG. 6B is a schematic diagram illustrating an LCG configuration with cast-type and HARQ feedback mode implicitly;

FIG. 7A is a schematic diagram illustrating a SL-BSR structure with an index that may reflect destination and cast-type pair;

FIG. 7B is a schematic diagram illustrating examples of destination and cast-type pair reporting in SidelinkUEInformation (SUI);

FIG. 7C is a schematic diagram illustrating an example of LCG configuration;

FIG. 7D is a schematic diagram illustrating another example of LCG configuration;

FIG. 7E is a schematic diagram illustrating a SL-BSR MAC CE format with a newly constructed index;

FIG. 8 is a schematic diagram illustrating a SL-BSR MAC CE format with multiple buffer size fields;

FIG. 9 is a flow chart illustrating steps of SL BSR reporting by UE according to one embodiment;

FIG. 10 is a flow chart illustrating steps of SL BSR reporting by NE according to one embodiment.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

For example, the disclosed embodiments may be implemented as a hardware circuit comprising custom very-large-scale integration (VLSI) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, one or more embodiments may take the form of a program product embodied in one or more computer readable storage devices storing machine readable code, computer readable code, and/or program code, referred to hereafter as “code”. The storage devices may be tangible, non-transitory, and/or non-transmission.

Any combination of one or more computer readable media may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

A non-exhaustive list of more specific examples of the storage device may include the following: an electrical connection having one or more wires, a portable computer diskette, a hard disk, a random-access memory (RAM), a read-only memory (ROM), an erasable programmable read-only memory (EPROM, or Flash memory), a portable Compact Disc Read-Only Memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Reference throughout this specification to “one embodiment”, “an embodiment”, “an example”, “some embodiments”, or similar language means that a particular feature, structure, or characteristic described in connection with the embodiment is included in at least one embodiment. Thus, appearances of the phrases “in one embodiment”, “in an embodiment”, “in some embodiments”, and similar language throughout this specification may, but do not necessarily, all refer to the same embodiment(s), but mean “one or more embodiments”. It may or may not include all the embodiments disclosed. Features, structures, elements, or characteristics described in connection with one or some embodiments are also applicable to other embodiments, unless expressly specified otherwise. The terms “including”, “comprising”, “having”, and variations thereof mean “including but not limited to”, unless expressly specified otherwise.

An enumerated listing of items does not imply that any or all of the items are mutually exclusive, unless expressly specified otherwise. The terms “a”, “an”, and “the” also refer to “one or more” unless expressly specified otherwise.

Throughout the disclosure, the terms “first”, “second”, “third”, and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step”.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code executed on the computer or other programmable apparatus provides processes for implementing the functions or acts specified in the schematic flowchart diagrams and/or schematic block diagram.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved. Other steps and methods may be conceived that are equivalent in function, logic, or effect to one or more blocks, or portions thereof, to the illustrated Figures.

The description of elements in each figure may refer to elements of proceeding figures. Like-numbers refer to like-elements in all figures, including alternate embodiments of like-elements.

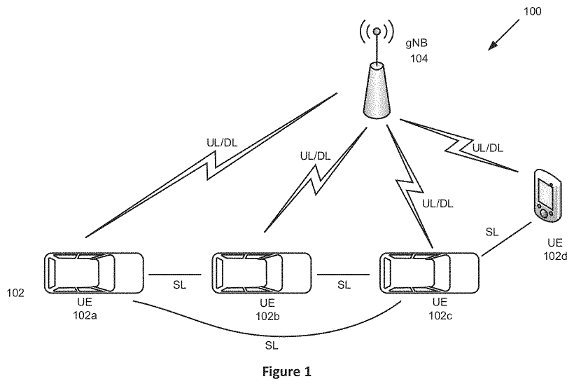

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE.

Direct or indirect communication link between two or more NEs 104 may be provided.

In a V2X network, the UEs may be a vehicle or vehicle carried device 102a, 102b, 102c, or a pedestrian carried device 102d. Sidelink (SL) is a special kind of communication mechanism between UEs, i.e., Device-to-Device (D2D) communication, without going through a base station 104. In this case, the communication with a base station is not required, and proximity service (ProSe) is the feature that specifies the architecture of the direct communication between UEs. As part of ProSe service, a new D2D interface (designated as PC5, also known as sidelink at the physical layer) was introduced. Sidelink may refer to the direct communication among vehicles and other devices (e.g. V2V, V2I), and it uses PC5 interface. PC5 refers to a reference point where user equipment (UE), i.e., a mobile terminal, directly communicates with another UE over the direct channel.

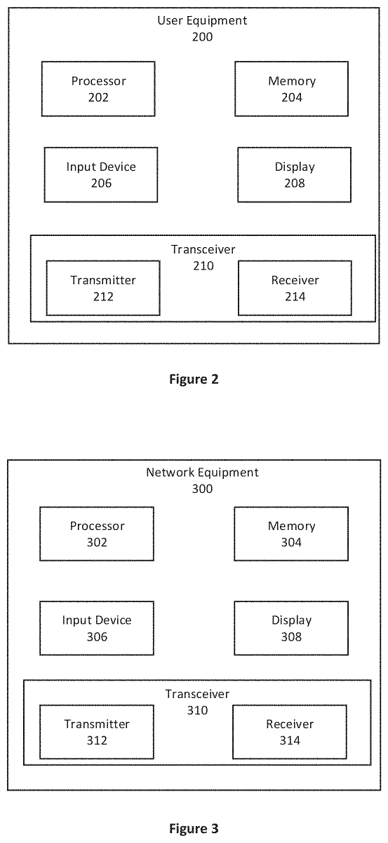

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audio, and/or haptic signals. In some embodiments, the display 208 includes an electronic display capable of outputting visual data to a user. For example, the display 208 may include, but is not limited to, an LCD display, an LED display, an OLED display, a projector, or a similar display device capable of outputting images, text, or the like to a user. As another non-limiting example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audio alert or notification (e.g., a beep or chime). In some embodiments, the display 208 includes one or more haptic devices for producing vibrations, motion, or other haptic feedback. In some embodiments, all or a portion of the display 208 may be integrated with the input device 206. For example, the input device 206 and the display 208 may form a touchscreen or a similar touch-sensitive display. In other embodiments, the display 208 may be located near the input device 206.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, in some embodiments, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. For example, the processor 302 may control the transceiver 310 to receive a Physical Uplink Control Channel (PUCCH) resource and/or a Physical Uplink Shared Channel (PUSCH) resource. In another example, the processor 302 may control the transceiver 310 to transmit DL signals containing various configuration data to the UE 200, as described above.

The transceiver 310, in one embodiment, is configured to communicate wirelessly with the UE 200. In certain embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, wherein the transceiver 310 includes a transmitter 312 and a receiver 314 for each cell or cell sector.

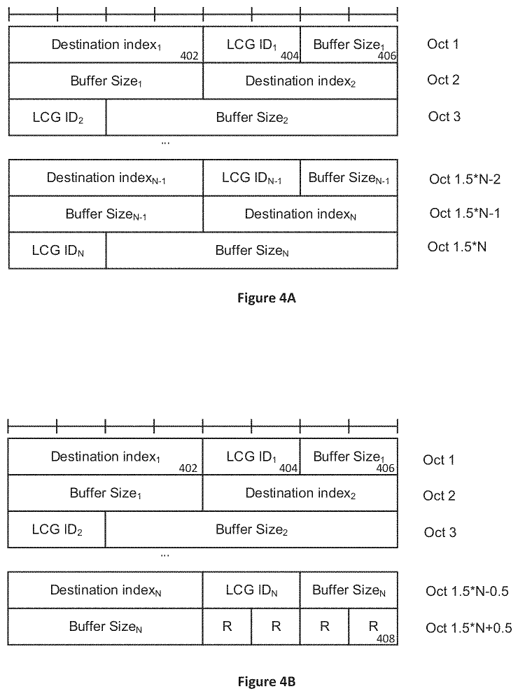

FIGS. 4A and 4B show Sidelink BSR and Truncated Sidelink BSR MAC control elements for even number of entries (N) and odd N, respectively. Each entry of the BSR include a Destination Index field 402, a LCG ID field 404 and a corresponding Buffer Size field 406 per reported target group.

For V2X communication, the destination Layer-2 ID, which is created by the V2X layer, is used to identify the specific V2X service or device. During Logical Channel Prioritization (LCP), data of different destination IDs cannot be multiplexed to the same MAC Protocol Data Unit (PDU) for transmission, for the data of different destination IDs could be for different target UEs. An LCP principle that the same MAC PDU needs to multiplex data of the same destination ID, which was applied to LTE V2X communication, is also applied to NR V2X communication.

In NR V2X, three cast types (unicast, groupcast, broadcast) for data transmission on sidelink are introduced, to fulfill more stringent Quality of Service (QoS) requirement of NR V2X service. For different cast types, the same destination ID may be used. For example, unicast may use destination ID 1, and groupcast may also use destination ID 1 for data transmission. Thus during LCP, besides considering destination restriction, cast type restriction needs also be considered. That is, only the data of the SL Logical Channels (LCHs) belonging to the same destination and the same cast type may be multiplexed into the MAC PDU to be transmitted.

Additionally, in NR V2X, HARQ feedback-based retransmission is introduced, to increase the resource utilization efficiency compared with LTE V2X blind retransmission scheme, while blind retransmission scheme is also inherited from LTE V2X. To utilize both schemes in NR V2X, HARQ feedback may be enabled or disabled according to the configuration or reconfiguration for specific transport block. When HARQ feedback is enabled, HARQ feedback-based retransmission will be used; otherwise, blind retransmission scheme will be used. During LCP procedure, HARQ feedback enable/disable should be also considered as well. That is, LCP will take HARQ Acknowledgement or Negative Acknowledgement (A/N) enabled/disabled into consideration, for example, a packet with HARQ enabled will be multiplexed only with other packets with HARQ feedback enabled.

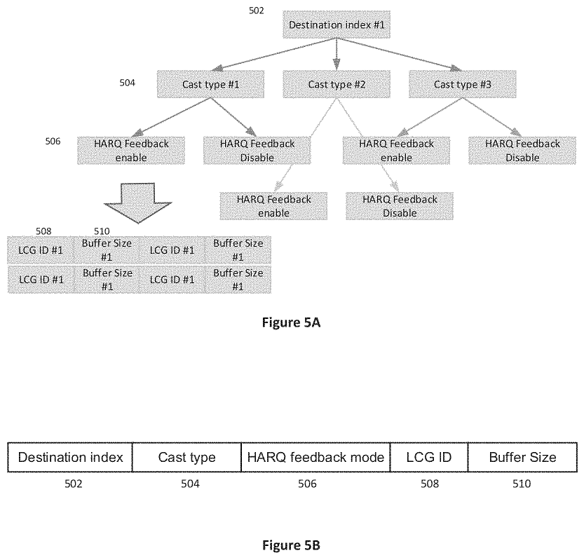

In some embodiments, at least one of additional fields of: cast-type information, and HARQ feedback mode information may be introduced in the SL-BSR MAC CE as shown in FIGS. 5A and 5B.

One LCG could contain LCHs with different cast-types and different HARQ feedback modes. With cast-type field and HARQ feedback mode field, the UE may report the buffer size information for those LCHs with cast-type and HARQ feedback mode in LCG for specific destination. New SL-BSR MAC CE will contain at least one of the fields of cast-type information, and HARQ feedback information.

FIG. 5A is a schematic diagram illustrating a SL-BSR MAC CE format structure considering LCP restriction. For each Destination ID 502, e.g. destination index #1, three cast types 504 are possible, e.g. cast type #1, cast type #2, and cast type #3. The three cast types may corresponds to unicast, groupcast, and broadcast, respectively. For each cast type, two HARQ feedback modes 506 are possible, i.e. HARQ feedback enable and HARQ feedback disable. For any particular combination of destination ID, cast type, and HARQ feedback mode, a list of LCG ID 508 and buffer size 510 may be reported, e.g. LCG ID #1, Buffer Size #1, LCG ID #2, Buffer Size #2, etc.

FIG. 5B is a schematic diagram illustrating a SL-BSR MAC CE format with a cast type field and a HARQ feedback mode field. The SL-BSR MAC CE may include five fields, i.e. Destination index 502, Cast type 504, HARQ feedback mode 506, LCG ID 508, and Buffer Size 510. Other orders or sequences of the fields may be possible.

In some examples, network, or gNB, will configure LCGs for the UE based on destination ID, without considering cast type and HARQ feedback mode when configuring LCG. This means in one LCG, there are LCHs with different cast types, and different HARQ feedback modes. And LCHs may be classified and configured into one LCG according to other QoS profile e.g. PC5 QoS Indicator (PQI), Guaranteed Flow Bit Rate (GFBR)/Maximum Flow Bit Rate (MFBR), range etc.

When a UE requires SL resource for SL V2X transmission, the UE will report SL-BSR to gNB. In such SL-BSR, at least one of the cast-type field or the HARQ feedback mode field is contained, in order to report the buffer size of LCHs in one LCG with the same cast-type or HARQ feedback mode configuration. When the gNB receives such kind of SL-BSR, the gNB will know the buffer size of LCHs in one LCGs with specific cast-type or HARQ feedback mode for specific destination address. The gNB then may schedule corresponding SL resource for the UE. This arrangement provides full flexibility to report the buffer size to the gNB, but may introduce overhead in SL-BSR reporting.

In this SL-BSR, the cast-type field may be one of unicast, groupcast or broadcast. Alternatively, the cast-type field may be an index or information that may represent one of unicast, groupcast or broadcast. HARQ feedback mode refers to HARQ feedback enable or HARQ feedback disable. If the HARQ feedback is enabled, SL data will be retransmitted according to HARQ feedback on sidelink. That is, if a HARQ NACK is received from a Rx UE, then the SL data will be retransmitted from the Tx UE. If a HARQ ACK is received from the Rx UE, then the SL data will not be retransmitted. On the other hand, if the HARQ feedback is disabled, the SL data will be retransmitted blindly, that is, no HARQ feedback is sent from the RX UE and the SL data will be blindly retransmitted.

Accordingly, the UE may arrange the buffer size information for sidelink transmission into a plurality of groups based on a destination ID and at least one selected from a group consisting of: a cast type and a Hybrid Automatic Repeat Request (HARQ) feedback mode; and subsequently transmits the buffer size information, according to the buffer groups using the SL-BSR MAC CE format shown in FIG. 5B for example.

The gNB receives buffer size information for sidelink transmission in the SL-BSR MAC CE format shown in FIG. 5B for example. That is, the buffer size information being arranged into a plurality of groups based on a destination ID and at least one selected from a group consisting of: a cast type and a Hybrid Automatic Repeat Request (HARQ) feedback mode. The gNB may than schedule radio resources for SL transmission based on the buffer size information, according to the buffer groups.

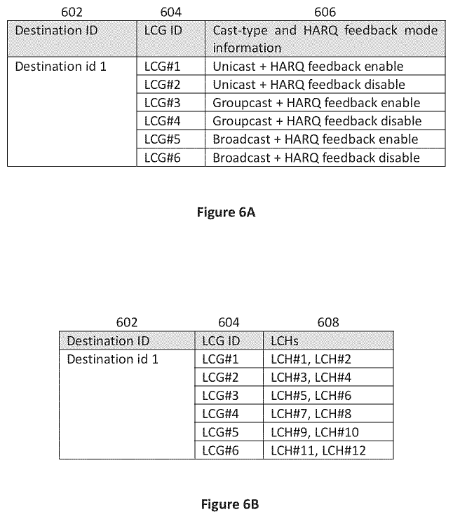

In some other embodiments, the network (NW) may configure each LCG with the associated cast-type, and HARQ feedback mode, and indicate to the UE via, for example, RRC signaling. Examples of LCG configuration are shown in FIGS. 6A and 6B. The SL BSR format shown in FIGS. 4A and 4B will not be changed. Instead, each LCG will be configured with a cast type and HARQ feedback mode explicitly or implicitly, so that the UE will group LCHs with the same cast type and HARQ feedback mode into the same LCG.

The LCG may be configured with the associated cast-type or HARQ feedback mode explicitly as shown in FIG. 6A. The LCG configuration may include three fields: Destination ID 602, LCG ID 604, Cast-type and HARQ feedback mode information 606. Each LCG is associated with unique Cast-type and HARQ feedback mode information 606. Each LCG is configured with one of combinations of cast-types and HARQ feedback modes. Then, the UE will group LCHs with the same cast-type and HARQ feedback mode into the same LCG, and report buffer sizes of corresponding LCGs in SL-BSR to the gNB.

Alternatively, the LCG may be configured with the associated cast-type or HARQ feedback mode implicitly as shown in FIG. 6B. The LCG configuration may include three fields: Destination ID 602, LCG ID 604, and LCHs 608. Each LCG is associated with LCHs 608 as shown in FIG. 6B. Each LCG is configured with LCHs explicitly by the gNB, and these LCHs have the same cast-type and the same HARQ feedback mode. The UE may deduce corresponding cast-type and HARQ feedback mode for specific LCG according to the configuration, and report buffer sizes of corresponding LCGs in SL-BSR to the gNB.

The network will configure LCGs with at least one combination of cast-type and HARQ feedback mode. This means that, in one LCG, the cast-type is the same among all LCHs, and so is the HARQ feedback mode. In one example shown in FIG. 6A, LCG may be configured with the associated cast-type or HARQ feedback mode explicitly. Then, the UE will group LCHs with same cast-type and HARQ feedback mode into the same LCG. When the UE reports SL-BSR, the buffer size of each LCG will be calculated according to the grouped LCHs in the LCG. In another example shown in FIG. 6B, LCG may be configured with the associated cast-type or HARQ feedback mode implicitly. The UE may deduce corresponding cast-type and HARQ feedback mode for the specific LCG according to the configuration before the UE reports SL-BSR to the gNB. It assumes that cast-type and HARQ feedback mode is aligned with LCH QoS requirement and may be grouped together when the cast-type and HARQ feedback mode are the same.

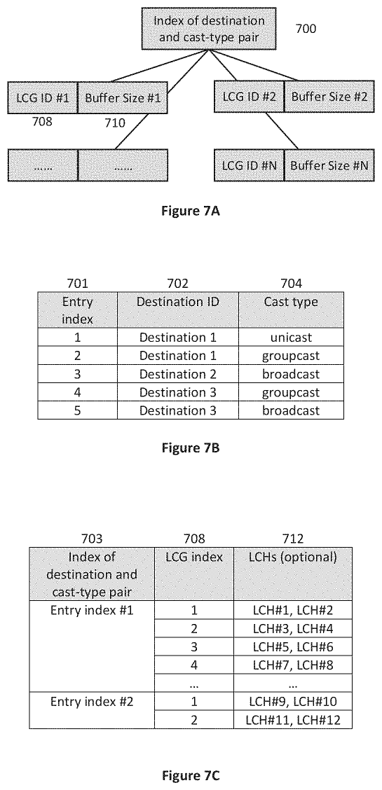

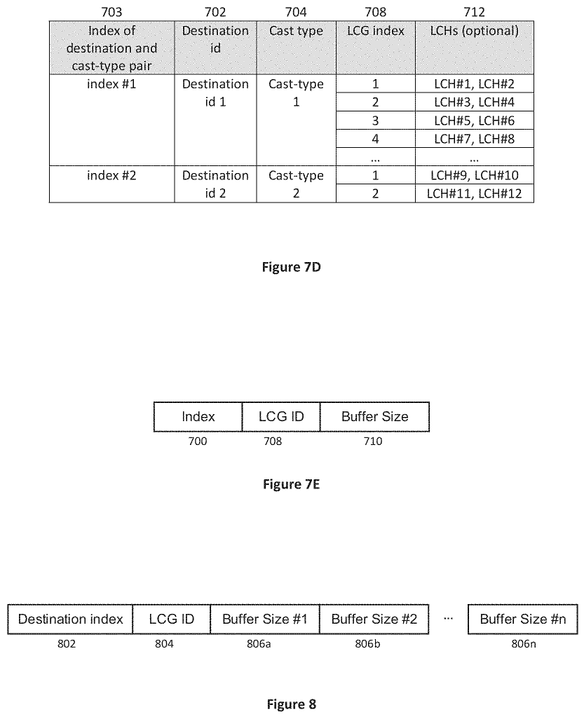

In some further embodiments, the UE may use destination and cast type pair index in the SL-BSR MAC CE, to indicate a destination and cast type pair that is associated with a LCG. LCGs are configured per destination and cast-type pair, as shown in FIGS. 7A to 7E.

FIG. 7A is a schematic diagram illustrating a SL-BSR structure with an index that may reflect destination and cast-type pair. The index of destination and cast type pair 700 may be linked to different groups of LCG ID 708 and Buffer Size 710.

The index 700 that represents destination-cast type pair, may be either an entry index 701, as shown in FIG. 7B, of destination and cast-type pair information derived based on gNB's reception of SidelinkUEInformation (SUI) reported by the UE, or a destination-cast type pair index 703, as shown in FIGS. 7C and 7D, that may be explicitly configured by the NW for the LCGs. The HARQ feedback mode may either be configured for the specific LCG as shown in FIGS. 6A and 6B, or by a new field in the SL-BSR MAC CE as shown in FIGS. 5A and 5B. In some embodiments, the index 700 may represent combinations of: the destination id, the cast type, and the HARQ feedback mode.

In one example, an entry index 701 may be implicitly mapped to the pair of destination and cast-type information. FIG. 7B is a schematic diagram illustrating examples of destination and cast-type pair reporting in the SUI. The report may include two fields: Destination ID 702, and Cast type 704. The UE reports a list of {(destination 1, cast-type 1), (destination 2, cast-type 2), . . . (destination n, cast-type n)} to gNB. The entry index 701 may be assigned by the gNB, for example, 1 for the first pair is 1, 2 for the second pair 2, . . . and n for the nth pair. The NW, or gNB, and UE will use the entry index 701 which may represent destination and cast-type pair information, instead of destination id, for SL-BSR reporting and subsequent resource allocation. In one example, the UE will report each destination and cast-type pair to the gNB in SidelinkUEInformation (SUI), as shown in FIG. 7B for example.

Each pair contains both destination ID information and cast-type information. Then, when the gNB configures LCGs, the gNB will use the entry index 701 of destination and cast-type pair in the SUI to indicate which destination and cast-type is associated with the LCG.

Then, when the UE reports SL-BSR to the gNB, the UE will use this index 701 of destination and cast-type pair in SL-BSR MAC CE format. After the gNB receives the SL-BSR, the gNB will know which destination and cast-type pair is associated with the buffer size of the specific LCG.

In another example, as shown in FIGS. 7C and 7D, the NW will explicitly configure LCG for the UE with destination and cast-type pair information and corresponding index 703. That is, when the NW configures LCG for the UE, the NW will explicitly indicate the index of destination and cast-type pair, and the corresponding destination and cast-type associated with this LCG. FIG. 7C is a schematic diagram illustrating an example of LCG configuration. The LCG configuration may include an index of destination and cast type pair field 703, and a LCG index field 708. Optionally, an LCHs field 712 may also be included. FIG. 7D is a schematic diagram illustrating another example of LCG configuration. In addition to the fields shown in FIG. 7C, two further fields, Destination ID 702 and Cast type 704, may also be included.

In the example, when the UE reports SL-BSR to the gNB, the UE will use this explicitly configured index of destination and cast-type pair in SL-BSR MAC CE format. After the gNB receives the SL-BSR, the gNB will know which destination and cast-type pair is associated with the buffer size of the LCG.

FIG. 7E is a schematic diagram illustrating a SL-BSR MAC CE format with a newly constructed index. The SL-BSR MAC CE format includes an Index field 700, a LCG ID field 708, and a Buffer Size field 710. In comparison with the SL-BSR MAC CE format shown in FIGS. 4A and 4B, the destination index field 402 is replaced by the index field 700. The index 700 may be the entry index 701 that is implicitly mapped to the pair of destination and cast-type information, or the index of destination and cast type pair 703 that is explicitly configured by the gNB indicating a destination and cast-type pair.

In some yet further embodiments, after each destination index and LCG ID fields, there may be multiple buffer size fields, mapping to different cast-type and HARQ feedback mode combinations, in the SL-BSR MAC CE. An exemplary SL-BSR MAC CE format is shown in FIG. 8. The mapping between the multiple buffer size fields and corresponding cast-type and HARQ feedback mode configurations, may be fixed in the specification, or configured by the gNB.

FIG. 8 is a schematic diagram illustrating an SL-BSR MAC CE format with multiple buffer size fields. Instead of one buffer size field, this SL-BSR MAC CE format may include a buffer size #1 field 806a, a buffer size #2 field 806b . . . , and a buffer size #n field 806n.

In one example, the NW will configure the mapping between multiple buffer size fields and the corresponding cast-type and HARQ feedback mode configurations based on existing UE services, and indicate to the UE via RRC signaling. Then, the UE will report SL-BSR with multiple buffer size fields for each LCG ID of specific destination index. The NW will update the configuration when new service arrives, and the UE will report SL-BSR with multiple buffer size fields containing new service after correctly received new configuration.

In another example, the mapping between multiple buffer size fields and corresponding cast-type and HARQ feedback mode configurations is fixed in the NR specification, and the UE will always report SL-BSR with specified multiple buffer size fields for each LCG ID of specific destination index.

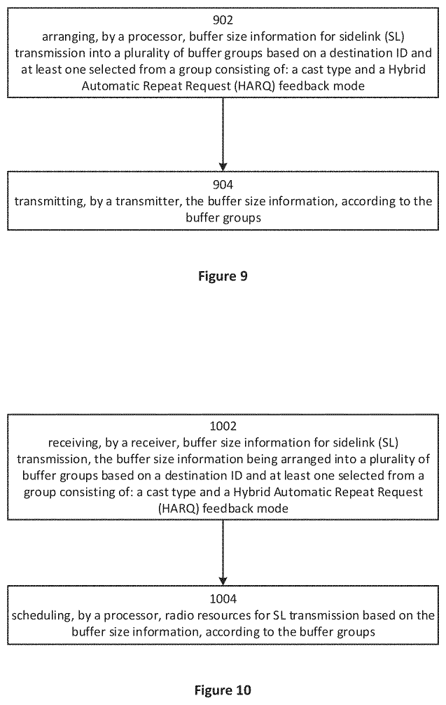

FIG. 9 is a flow chart illustrating steps of SL BSR reporting by UE according to one embodiment;

At step 902, the processor 202 of the UE 200 arranges buffer size information for sidelink (SL) transmission into a plurality of buffer groups based on a destination ID and at least one selected from a group consisting of: a cast type and a Hybrid Automatic Repeat Request (HARQ) feedback mode.

At step 904, the transmitter 212 transmits the buffer size information, according to the buffer groups.

In some embodiments, the receiver 214 receives configuration information according to which the processor 202 arranges the buffer size information into the plurality of buffer groups. The configuration information comprises the destination ID associated with a plurality of Logical Channel Groups (LCGs), each LCG being associated with: a unique cast type, a unique HARQ feedback mode, or a unique combination of the cast type and the HARQ feedback mode. Alternatively, the configuration information comprises the destination ID associated with a plurality of Logical Channel Groups (LCGs), each LCG being associated with a Logical Channel (LCH) or a plurality of LCHs that have a same cast type and/or a same HARQ feedback mode. Alternatively, the configuration information may comprise an index indicating a unique combination of the destination ID and the cast type.

In some other embodiments, the transmitter 212 transmits configuration information according to which the processor 202 arranges the buffer size information into the plurality of buffer groups. The configuration information may comprise unique combinations of the destination ID and the cast type.

In some embodiments, the processor 202 arranges the buffer size information into a plurality of buffer groups based on a destination ID, a cast type, and a HARQ feedback mode; and the transmitter 212 transmits the buffer size information as a buffer status report (BSR) comprising fields of: destination ID, LCG ID, cast type, HARQ feedback mode, and buffer size.

In some embodiments, the processor 202 arranges the buffer size information into a plurality of buffer groups based on a destination ID, a cast type, and a HARQ feedback mode; and the transmitter 212 transmits the buffer size information as a BSR comprising fields of: destination ID, LCG ID, and a plurality of buffer sizes; each buffer size being associated with: a unique cast type, a unique HARQ feedback mode, or a unique combination of the cast type and the HARQ feedback mode

FIG. 10 is a flow chart illustrating steps of SL BSR reporting by NE according to one embodiment.

At step 902, the receiver 314 of the NE 300 receives buffer size information for sidelink (SL) transmission, the buffer size information being arranged into a plurality of buffer groups based on a destination ID and at least one selected from a group consisting of: a cast type and a Hybrid Automatic Repeat Request (HARQ) feedback mode.

At step 904, the processor 302 schedules radio resources for SL transmission based on the buffer size information, according to the buffer groups.

In some embodiments, the transmitter 312 transmits configuration information according to which the buffer size information is arranged into the plurality of buffer groups. In some other embodiments, the receiver 314 receives configuration information according to which the buffer size information is arranged into the plurality of buffer groups.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus, comprising:
a processor that arranges buffer size information for sidelink (SL) transmission into a plurality of buffer groups based on a destination ID and at least one selected from a group consisting of: a cast type and a Hybrid Automatic Repeat Request (HARQ) feedback mode; and
a transmitter that transmits the buffer size information, according to the buffer groups.

2. The apparatus of claim 1, further comprising a receiver that receives configuration information according to which the processor arranges the buffer size information into the plurality of buffer groups.

3. The apparatus of claim 2, wherein the configuration information comprises the destination ID associated with a plurality of Logical Channel Groups (LCGs), each LCG being associated with: a unique cast type, a unique HARQ feedback mode, or a unique combination of the cast type and the HARQ feedback mode.

4. The apparatus of claim 2, wherein the configuration information comprises the destination ID associated with a plurality of Logical Channel Groups (LCGs), each LCG being associated with a Logical Channel (LCH) or a plurality of LCHs that have a same cast type and/or a same HARQ feedback mode.

5. The apparatus of claim 2, wherein the configuration information comprises an index indicating a unique combination of the destination ID and the cast type.

6. The apparatus of claim 1, wherein the transmitter further transmits configuration information according to which the processor arranges the buffer size information into the plurality of buffer groups.

7. The apparatus of claim 6, wherein the configuration information comprises unique combinations of the destination ID and the cast type.

8. The apparatus of claim 1, wherein the processor arranges the buffer size information into a plurality of buffer groups based on the destination ID, the cast type, and the HARQ feedback mode; and the transmitter transmits the buffer size information as a buffer status report (BSR) comprising fields of: destination ID, LCG ID, cast type, HARQ feedback mode, and buffer size.

9. The apparatus of claim 1, wherein the processor arranges the buffer size information into a plurality of buffer groups based on the destination ID, the cast type, and the HARQ feedback mode; and the transmitter transmits the buffer size information as a BSR comprising fields of: destination ID, LCG ID, and a plurality of buffer sizes; each buffer size being associated with: a unique cast type, a unique HARQ feedback mode, or a unique combination of the cast type and the HARQ feedback mode.

10. An apparatus, comprising:
a receiver that receives buffer size information for sidelink (SL) transmission, the buffer size information being arranged into a plurality of buffer groups based on a destination ID and at least one selected from a group consisting of: a cast type and a Hybrid Automatic Repeat Request (HARQ) feedback mode; and
a processor that schedules radio resources for SL transmission based on the buffer size information, according to the buffer groups.

11. The apparatus of claim 10, further comprising a transmitter that transmits configuration information according to which the buffer size information is arranged into the plurality of buffer groups.

12. The apparatus of claim 11, wherein the configuration information comprises the destination ID associated with a plurality of Logical Channel Groups (LCGs), each LCG being associated with: a unique cast type, a unique HARQ feedback mode, or a unique combination of the cast type and the HARQ feedback mode.

13. The apparatus of claim 11, wherein the configuration information comprises the destination ID associated with a plurality of Logical Channel Groups (LCGs), each LCG being associated with a Logical Channel (LCH) or a plurality of LCHs that have a same cast type and/or a same HARQ feedback mode.

14. The apparatus of claim 11, wherein the configuration information comprises an index indicating a unique combination of the destination ID and the cast type.

15. The apparatus of claim 10, wherein the receiver further receives configuration information according to which the buffer size information is arranged into the plurality of buffer groups.

16. The apparatus of claim 15, wherein the configuration information comprises unique combinations of the destination ID and the cast type.

17. The apparatus of claim 10, wherein the buffer size information comprises fields of: destination ID, LCG ID, cast type, HARQ feedback mode, and buffer size.

18. The apparatus of claim 10, wherein the buffer size information comprises fields of: destination ID, LCG ID, and a plurality of buffer sizes; each buffer size being associated with: a unique cast type, a unique HARQ feedback mode, or a unique combination of the cast type and the HARQ feedback mode.

19. A method, comprising:
arranging, by a processor, buffer size information for sidelink (SL) transmission into a plurality of buffer groups based on a destination ID and at least one selected from a group consisting of: a cast type and a Hybrid Automatic Repeat Request (HARQ) feedback mode; and
transmitting, by a transmitter, the buffer size information, according to the buffer groups.

20. The method of claim 19, further comprising receiving, by a receiver, configuration information according to which the processor arranges the buffer size information into the plurality of buffer groups.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
